(19) United States
(12) Patent Application Publication
(10) Pub. No.: US 2026/0285171 A1
(43) Pub. Date: Sep. 24, 2026

(54) FUEL CELL VEHICLE

(71) Applicant: HONDA MOTOR CO., LTD., TOKYO (JP)

(72) Inventor: Takuya KANDA, WAKO-SHI (JP)

(21) Appl. No.: 19/567,849

(22) Filed: Mar. 16, 2026

(30) Foreign Application Priority Data
Mar. 21, 2025 (JP) 2025-046984

(51) Int. Cl. B60L 50/71; B60L 50/72; B62D 21/02; H01M 8/2404

(52) U.S. Cl. CPC B60L 50/71; B60L 50/72; B62D 21/02; H01M 8/2404; H01M 2250/20

(57) ABSTRACT

A fuel cell vehicle includes a first subframe to which a first fuel cell module is fixed, a second subframe to which a second fuel cell module is fixed, and a connecting member configured to connect the first subframe and the second subframeto each other. The first subframe, the second subframe, and the connecting member are fastened to a pair of side frames of a vehicle body frame by a fastening member.

### CROSS-REFERENCE TO RELATED APPLICATIONS

This application is based upon and claims the benefit of priority from Japanese Patent Application No. 2025-046984 filed on Mar. 21, 2025, the contents of which are incorporated herein by reference.

### BACKGROUND OF THE INVENTION

### Field of the Invention

The present disclosure relates to a fuel cell vehicle.

### Description of the Related Art

JP 2008-290470 A discloses a fuel cell vehicle equipped with a plurality of fuel cell modules fixed to a frame of a vehicle body. The fuel cell vehicle has a cross-member (subframe) that is fixed to each fuel cell module. Each fixed cross-member of each fuel cell module is fastened to a pair of side frames of the vehicle body, respectively.

### SUMMARY OF THE INVENTION

In the case of the fuel cell vehicle disclosed in JP 2008-290470 A, each of a plurality of fuel cell modules is provided with a cross member. However, because each of a plurality of cross members is fixed to the side frame, the plurality of fuel cell modules does not have a good ease of assembly with respect to the side frame.

The present disclosure aims to solve the aforementioned problems.

An aspect of the present disclosure is fuel cell vehicle including a vehicle body frame including a pair of side frames facing each other in a vehicle width direction, a plurality of fuel cell modules, and a fixing structure configured to fix the plurality of fuel cell modules to the pair of side frames via a fastening member, wherein the plurality of fuel cell modules include a first fuel cell module, and a second fuel cell module arranged rearward of the first fuel cell module in a front-rear direction of the vehicle, the fixing structure includes a first subframe to which the first fuel cell module is fixed, a second subframe to which the second fuel cell module is fixed, and a connecting member configured to connect a rear end portion of the first subframe and a front end portion of the second subframe to each other, and the first subframe, the second subframe, and the connecting member are fastened to the pair of side frames by the fastening member.

According to the present disclosure, the ease of assembly of the plurality of fuel cell modules with respect to the pair of side frames can be improved.

The above and other objects, features, and advantages of the present invention will become more apparent from the following description when taken in conjunction with the accompanying drawings, in which a preferred embodiment of the present invention is shown by way of illustrative example.

### BRIEF DESCRIPTION OF THE DRAWINGS

FIG. 1 is a schematic plan view of a fuel cell vehicle according to an embodiment of the present disclosure;

FIG. 2 is a cross-sectional view taken along a line II-II of FIG. 1;

FIG. 3 is an enlarged plan view of FIG. 1; and

FIG. 4 is an enlarged cross-sectional view of FIG. 2.

### DETAILED DESCRIPTION OF THE INVENTION

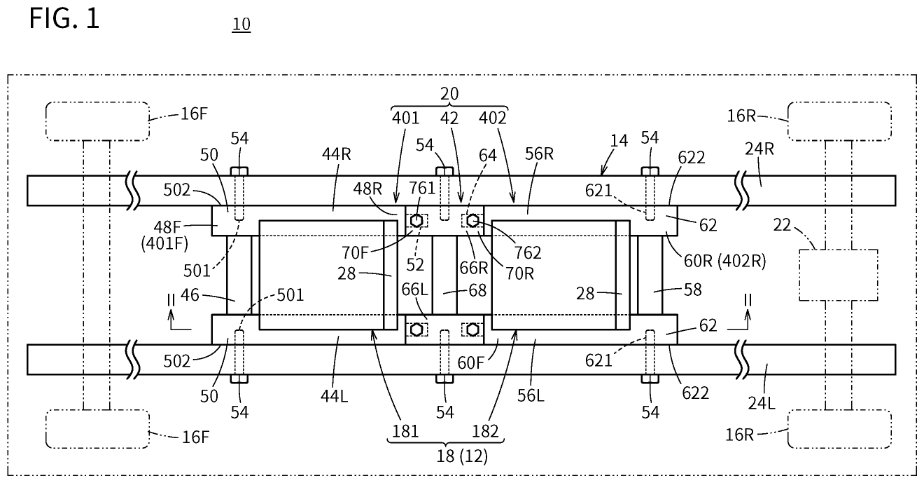

As shown in FIG. 1, a fuel cell vehicle 10 according to the present embodiment is equipped with a fuel cell system 12. A fuel cell vehicle 10 includes a vehicle body frame 14, front wheels 16F, rear wheels 16R, a plurality of fuel cell modules 18, a fixing structure 20, and a motor 22. The motor 22 is operated by power supplied from the fuel cell modules 18 and drives at least the front wheels 16F or the rear wheels 16R. The motor 22 is fixed to, for example, the vehicle body frame 14.

The vehicle body frame 14 is provided with a pair of side frames 24L, 24R. Each of the pair of side frames 24L, 24R extends along the front-rear direction of the fuel cell vehicle 10 (hereinafter, also referred to as vehicle 10). The pair of side frames 24L, 24R face each other in the vehicle width direction of the vehicle 10. The pair of side frames 24L, 24R are provided in parallel apart from each other in the vehicle width direction.

The plurality of fuel cell modules 18 are provided along the vehicle front-rear direction (hereinafter referred to as the “front-rear direction”) of the vehicle 10. The plurality of fuel cell modules 18 includes a first fuel cell module 181 and a second fuel cell module 182. The first fuel cell module 181 and the second fuel cell module 182 are arranged in parallel along the front-rear direction of the vehicle 10. Hereinafter, a vehicle front side of the vehicle 10 is referred to as “front”, “frontward”, and a vehicle rear side of the vehicle 10 is referred to as “rear”, “rearward”.

The second fuel cell module 182 is arranged rearward of the first fuel cell module 181 in the front-rear direction of the vehicle 10. A case where the plurality of fuel cell modules 18 are composed of two fuel cell modules that are the first fuel cell module 181 and the second fuel cell module 182 will be described below. The configuration is not limited to a case where the plurality of fuel cell modules 18 are composed of two fuel cell modules 18. The number of fuel cell modules 18 may be three or more.

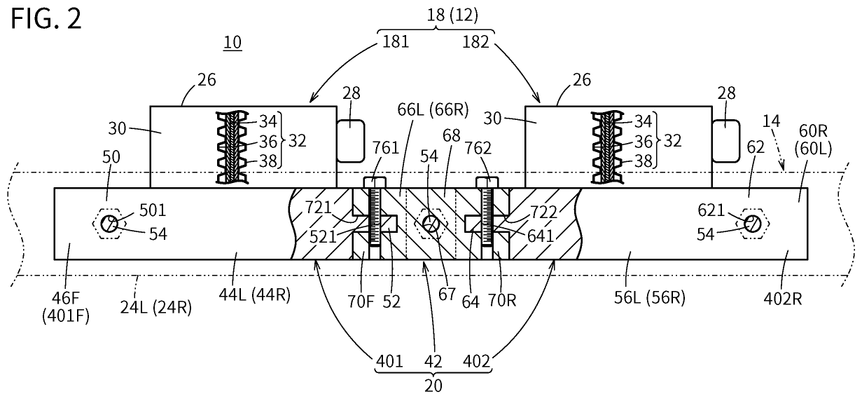

Each of the first fuel cell module 181 and the second fuel cell module 182 is fixed to the pair of side frames 24L, 24R by the fixing structure 20. Additionally, it is preferable that the first fuel cell module 181 and the second fuel cell module 182 are arranged more inward in the vehicle width direction than the outer ends in the width direction of the side frames 24L and 24R, respectively. It is more preferable to arrange each of the first fuel cell module 181 and the second fuel cell module 182 further inward in the vehicle width direction than the inner ends in the width direction of the side frames 24L and 24R, respectively. As shown in FIG. 2, each of the first fuel cell module 181 and the second fuel cell module 182 includes a fuel cell stack 26 and a plurality of auxiliary devices 28 for driving the fuel cell stack 26. The fuel cell stack 26 has a stack case 30 and a plurality of power generating cells 32. The stack case 30 accommodates a plurality of power generating cells 32.

The plurality of power generating cells 32 generates power through an electrochemical reaction between an anode gas (fuel gas such as hydrogen) supplied from an anode system device and a cathode gas (oxygen containing gas such as air) supplied from a cathode system device. Each power generating cell 32 is composed of a membrane electrode assembly 34 and two separators 36, 38 sandwiching the membrane electrode assembly 34. The plurality of power generating cells 32 are stacked in the front-rear direction of the vehicle 10 with electrode surfaces in a standing posture. An upper surface of the fuel cell stack 26 is located at a higher position than the pair of side frames 24L, 24R.

As shown in FIG. 1, the fixing structure 20 fixes the plurality of fuel cell modules 18 to the pair of side frames 24L, 24R via a fastening members 54. The fixing structure 20 includes a first subframe401, a second subframe402, and a connecting member 42.

The first fuel cell module 181 is fixed to the first subframe401. An upper surface of the first subframe401 is in contact with a lower surface of the stack case 30 of the first fuel cell module 181 (see FIG. 2). A plurality of first fuel cell modules 181 may be fixed to the first subframe 401.

The first subframe 401 includes a pair of first side bars 44L, 44R and a first connecting bar 46.

Each of the pair of first side bars 44L, 44R extends in the front-rear direction of the vehicle 10 and is apart from each other in the vehicle width direction. In plan view, each first side bar 44L, 44R is arranged inward in the width direction of the pair of side frames 24L, 24R. The configuration is not limited to a case where the first side bars 44L, 44R are arranged inward in the width direction of each of the pair of side frames 24L, 24R. For example, each first side bar 44L, 44R may overlap each of the pair of side frames 24L, 24R in plan view.

Each of the pair of first side bars 44L, 44R includes a first bar front end portion 48F and a first bar rear end portion 48R. The first bar front end portion 48F is provided at the front end of the first side bars 44L, 44R in the front-rear direction of the vehicle 10. The first bar rear end portion 48R is provided at the rear end of the first side bars 44L, 44R in the front-rear direction of the vehicle 10.

The first connecting bar 46 connects each end portion of the pair of first side bars 44L, 44R to each other. The first connecting bar 46 extends in the vehicle width direction. The first bar front end portions 48F of the first side bars 44L, 44R are connected to each other by the first connecting bar 46. The extending direction (front-rear direction) of each first side bar 44L, 44R and the extending direction (width direction) of the first connecting bar 46 are orthogonal to each other.

The first subframe401 further includes a first fastened portion 50 and a first connected portion 52. The first fastened portion 50 is fastened to the side frames 24L, 24R by the fastening member 54. The first fastened portion 50 is provided on a front end portion 401F of the first subframe401. The first fastened portion 50 is provided on the front end portions 401F of the pair of first side bars 44L, 44R, respectively. That is, a pair of first fastened portions 50 is provided. The configuration is not limited to a case where the first fastened portion 50 is provided on the front end portion 401F of the first subframe401. For example, the first fastened portion 50 may be provided at a rear end portion of the first subframe401 or may be provided at a central portion between the front end portion 401F and the rear end portion.

The first fastened portion 50 has a first fastening hole 501 to which the fastening member 54 is fastened. The first fastening hole 501 extends in the vehicle width direction of the first side bars 44L, 44R. The first fastening hole 501 opens on a first fastening surface 502 facing the side frames 24L, 24R.

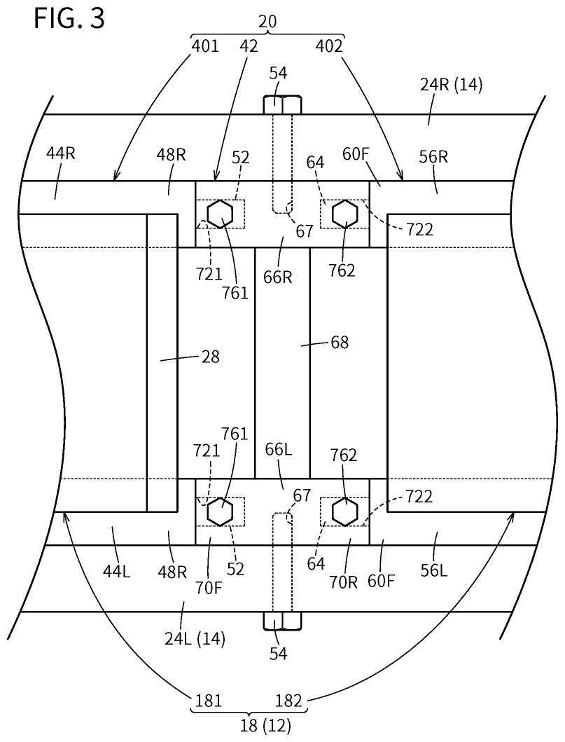

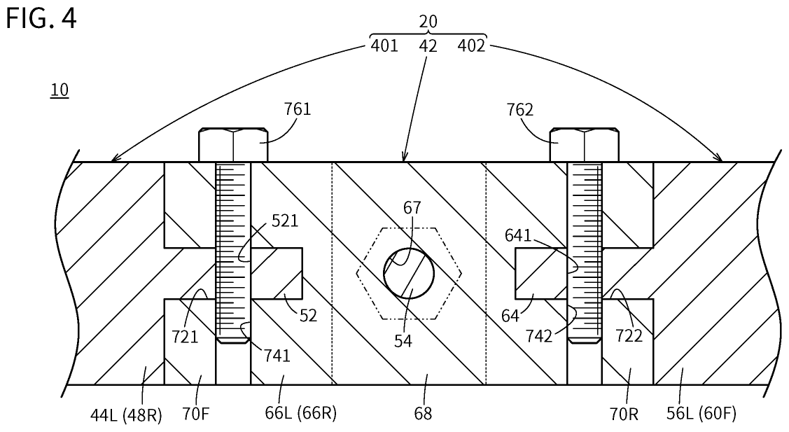

As shown in FIG. 3, the first connected portion 52 is provided at each of the pair of first bar rear end portions 48R. Each first connected portion 52 projects rearward from the pair of first bar rear end portions 48R (see FIG. 4). The first connected portion 52 has a first hole portion 521 penetrating in the up-down direction of the vehicle 10.

As shown in FIG. 1, the second fuel cell module 182 is fixed to the second subframe402. The second subframe402 is arranged behind the first subframe401 in the front-rear direction of the vehicle body frame 14. An upper surface of the second subframe402 is in contact with the lower surface of the stack case 30 of the second fuel cell module 182 (see FIG. 2). A plurality of second fuel cell modules 182 may be fixed to the second subframe 402.

The second subframe 402 includes a pair of second side bars 56L, 56R and a second connecting bar 58.

Each of the pair of second side bars 56L, 56R extends in the front-rear direction of the vehicle 10 and is apart from each other in the vehicle width direction. In plan view, each second side bar 56L, 56R is arranged inward in the width direction of the pair of side frames 24L, 24R. The configuration is not limited to a case where each second side bar 56L, 56R is arranged inward in the width direction of each of the pair of side frames 24L, 24R. For example, each second side bar 56L, 56R may overlap each of the pair of side frames 24L, 24R in plan view.

Each of the pair of second side bars 56L, 56R includes a second bar front end portion 60F and a second bar rear end portion 60R. The second bar front end portion 60F is provided at the front end of the second side bars 56L, 56R in the front-rear direction of the vehicle 10. The second bar rear end portion 60R is provided at the rear end of the second side bars 56L, 56R in the front-rear direction of the vehicle 10.

The second connecting bar 58 connects each end portion of the pair of second side bars 56L, 56R to each other. The second connecting bar 58 extends in the vehicle width direction. The second bar rear end portions 60R of the second side bars 56L, 56R are connected to each other by the second connecting bar 58. The extending direction (front-rear direction) of each second side bar 56L, 56R and the extending direction (width direction) of the second connecting bar 58 are orthogonal to each other.

As shown in FIG. 1, the second subframe402 further includes a second fastened portion 62 and a second connected portion 64. The second fastened portion 62 is fastened to the side frames 24L, 24R by the fastening member 54. The second fastened portion 62 is provided on a rear end portion 402R of the second subframe402. The second fastened portion 62 is provided on the rear end portions 402R of the pair of second side bars 56L and 56R, respectively. That is, a pair of second fastened portions 62 are provided. The configuration is not limited to a case where the second fastened portion 62 is provided at the rear end portion 402R of the second subframe402. For example, the second fastened portion 62 may be provided at a front end portion of the second subframe402 or may be provided at a central portion between the front end portion and the rear end portion 402R.

The second fastened portion 62 has a second fastening hole 621 to which the fastening member 54 is fastened. The second fastening hole 621 extends in the vehicle width direction of the second side bars 56L, 56R. The second fastening hole 621 open on a second fastening surface 622 facing the side frames 24L, 24R.

As shown in FIG. 3, the second connected portion 64 is provided at each of the pair of second bar front end portions 60F. Each second connected portion 64 projects forward from the pair of second bar front end portions 60F. The second connected portion 64 has a second hole portion 641 penetrating in the vertical direction of the vehicle 10.

The connecting member 42 is provided between the first subframe401 and the second subframe402 in the front-rear direction of the vehicle 10. As shown in FIG. 3, the connecting member 42 contacts the rear end portions of the pair of first subframes 401 and the front end portions of the pair of second subframes 402 and connects the rear end portions of the first subframes 401 and the front end portions of the second subframes 402 to each other.

The connecting member 42 includes a pair of frame connecting portions 66L, 66R and a connecting portion 68. Each of the pair of frame connecting portions 66L, 66R extends in the front-rear direction of the vehicle 10 and is apart from each other in the vehicle width direction. The frame connecting portion 66L connects the first bar rear end portion 48R of the first side bar 44L and the second bar front end portion 60F of the second side bar 56L to each other. The frame connecting portion 66R connects the first bar rear end portion 48R of the first side bar 44R and the second bar front end portion 60F of the second side bar 56R to each other.

Each of the frame connecting portions 66L, 66R has a third fastening hole 67 (see FIG. 3) to which the fastening member 54 is fastened. The third fastening hole 67 extends in the vehicle width direction of each of the frame connecting portions 66L and 66R. The third fastening holes 67 open on end faces facing the side frames 24L, 24R.

The frame connecting portions 66L, 66R further include a first connecting portion 70F and a second connecting portion 70R. The first connecting portion 70F is provided at front portions of the frame connecting portions 66L, 66R. The first connecting portion 70F is connected to each of the first bar rear end portions 48R of the pair of first side bars 44L, 44R. As shown in FIG. 4, the first connecting portion 70F includes a first engaging portion 721 and a first connecting hole 741.

The first engaging portion 721 is indented rearward from the front ends of the frame connecting portions 66L, 66R. Each of the first connected portions 52 of the pair of first side bars 44L and 44R is inserted into the first engaging portion 721. The first connection hole 741 is formed along the up-down direction of the vehicle 10. With the first connected portion 52 inserted into the first engaging portion 721, the first frame fastening member 761 is inserted into and fastened to the first connecting hole 741 via the first hole portion 521. The first frame fastening member 761 connects the first connecting portion 70F of the connecting member 42 and the rear end portion (first bar rear end portion 48R) of the first subframe401 (first side bars 44L, 44R, respectively).

The configuration is not limited to a case where the first engaging portion 721 is formed in a concave shape with respect to the frame connecting portions 66L, 66R, and the first connected portion 52 inserted into the first engaging portion 721 is formed in a convex shape toward the rear. For example, the first connected portion 52 may be formed in a concave shape toward the front, and the first engaging portion 721 may be formed in a convex shape that can be inserted into the first connected portion 52.

As shown in FIG. 3, the second connecting portion 70R is provided on the rear portion of the frame coupling portions 66L and 66R. The second connecting portion 70R is connected to each of the second bar front end portions 60F of the pair of second side bars 56L, 56R. As shown in FIG. 4, the second connecting portion 70R includes a second engaging portion 722 and a second connecting hole 742.

The second engaging portion 722 is indented forward from the rear ends of the frame connecting portions 66L, 66R. The second connected portions 64 of the pair of second side bars 56L and 56R are inserted into the second engaging portions 722. The second connection hole 742 is formed along the up-down direction of the vehicle 10. With the second connected portion 64 inserted into the second engaging portion 722, the second frame fastening member 762 is inserted into and fastened to the second connecting hole 742 via the second hole portion 641. The second frame fastening member 762 connects the second connecting portion 70R of the connecting member 42 and the front end portion (second bar front end portion 60F) of the second subframe402 (each second side bar 56L, 56R).

The configuration is not limited to a case where the second engaging portion 722 is formed in a concave shape with respect to the frame connecting portions 66L and 66R, and the second connected portion 64 inserted into the second engaging portion 722 is formed in a convex shape toward the front. For example, the second connected portion 64 may be formed in a concave shape toward the rear, and the second engaging portion 722 may be formed in a convex shape that can be inserted into the second connected portion 64.

As shown in FIG. 3, the connecting portion 68 extends in the vehicle width direction of the vehicle 10. The connecting portion 68 connects the pair of frame connecting portions 66L, 66R to each other. In the front-rear direction of the vehicle 10, the connecting portion 68 connects intermediate portions of the pair of frame connecting portions 66L, 66R to each other. The connecting member 42 is formed in an H-shape in plan view. The extending direction (front-rear direction) of each frame connecting portion 66L, 66R and the extending direction (width direction) of the connecting portion 68 are orthogonal to each other.

The first subframe401, the second subframe402, and the connecting member 42 are fastened to the pair of side frames 24L, 24R by a plurality of fastening members 54, respectively, in the vehicle width direction.

The present embodiment provides the following effects.

As shown in FIG. 3, the fixing structure 20 of the fuel cell vehicle 10 includes the first subframe401 to which the first fuel cell module 181 is fixed, a second subframe402 to which the second fuel cell module 182 is fixed, and a connecting member 42 that connects the first subframe401 and the second subframe402 to each other. The first subframe401, the second subframe402, and the connecting member 42 are fastened to the pair of side frames 24L, 24R by the fastening members 54, respectively.

According to the fuel cell vehicle 10, it is possible to improve the ease of the assembly of the plurality of fuel cell modules 18 (the first fuel cell module 181 and the second fuel cell module 182) with respect to the pair of side frames 24L and 24R.

As shown in FIG. 1, the first subframe401 includes the pair of first side bars 44L, 44R and the first connecting bar 46 that connects each end of the pair of first side bars 44L, 44R to each other. The second subframe 402 includes the pair of second side bars 56L, 56R and the second connecting bar 58 that connects each end of the pair of second side bars 56L, 56R to each other. The first bar front end portions 48F of the pair of first side bars 44L, 44R are connected to each other by the first connecting bar 46, and the second bar rear end portions 60R of the pair of second side bars 56L, 56R are connected to each other by the second connecting bar 58.

According to this configuration, the configurations of the first subframe 401 and the second subframe 402 can be simplified to reduce the weight.

The connecting member 42 is formed in an H-shape in plan view and includes the pair of frame connecting portions 66L, 66R that are parallel to each other, and the connecting portion 68 that connects the pair of frame connecting portions 66L, 66R to each other. The first bar rear end portion 48R of each of the pair of first side bars 44L, 44R and the second bar front end portion 60F of each of the pair of second side bars 56L, 56R are connected by the pair of frame connecting portions 66L, 66R, respectively.

According to this configuration, the first subframe401 and the second subframe402 can be more effectively connected by the H-shaped connecting member 42.

The first subframe401 has the first fastened portion 50, which is fastened to the side frames 24L, 24R by the fastening member 54. The second subframe402 has the second fastened portion 62, which is fastened to the side frames 24L, 24R by the fastening member 54. The first fastened portion 50 is provided on the front end portion 401F of the first subframe401, and the second fastened portion 62 is provided on the rear end portion 402R of the second subframe402.

According to this configuration, it is possible to fix the fuel cell module 18 to the side frames 24L, 24R in a stable posture by fixing the first fuel cell module 181 and the second fuel cell module 182 at distant positions in the front-rear direction of the fuel cell vehicle 10.

With respect to the above disclosure, the following supplementary notes are further disclosed.

### Supplementary Note 1

A fuel cell vehicle (10) includes a vehicle body frame (14) including a pair of side frames (24L, 24R) facing each other in a vehicle width direction, a plurality of fuel cell modules (18), and a fixing structure (20) configured to fix the plurality of fuel cell modules to the pair of side frames via a fastening member (54), wherein the plurality of fuel cell modules include a first fuel cell module (181), and a second fuel cell module (182) arranged rearward of the first fuel cell module in a front-rear direction of the vehicle, the fixing structure includes a first subframe(401) to which the first fuel cell module is fixed, a second subframe(402) to which the second fuel cell module is fixed, and a connecting member (42) configured to connect a rear end portion of the first subframeand a front end portion of the second subframeto each other, and the first subframe, the second subframe, and the connecting member are fastened to the pair of side frames by the fastening member.

According to such a fuel cell vehicle, the ease of assembly of the plurality of fuel cell modules to the pair of side frames can be improved.

### Supplementary Note 2

In the fuel cell vehicle described in Supplementary note1, the first subframemay include a pair of first side bars (44L, 44R) spaced apart from each other in the vehicle width direction, and a first connecting bar (46) configured to connect end portions of the pair of first side bars to each other, the second subframemay include a pair of second side bars (56L, 56R) spaced apart from each other in the vehicle width direction, and a second connecting bar (58) configured to connect end portions of the pair of second side bars to each other, and in the vehicle front-rear direction, bar front end portions (48F) of the pair of first side bars may be connected to each other by the first connecting bar, and bar rear end portions (60R) of the pair of second side bars may be connected to each other by the second connecting bar.

According to such a configuration, the configuration of each of the first and second subframes can be simplified to achieve weight reduction.

### Supplementary Note 3

In the fuel cell vehicle described in Supplementary note2, the connecting member may include a pair of frame connecting portions (66L, 66R) extending in the front-rear direction of the vehicle and arranged parallel with each other, and a connecting portion (68) configured to connect the pair of frame connecting portions to each other, the connecting member may be formed in an H-shape in a plan view, and bar rear end portions of the pair of the first side bars and bar front end portions of the pair of the second side bars may be connected by the pair of frame connecting portions.

According to such a configuration, the first and second subframes can be more effectively connected by the H-shaped connecting member.

### Supplementary Note 4

In the fuel cell vehicle described in Supplementary note1, the first subframemay include a first fastened portion (50) fastened to each of the side frames by the fastening member, the second subframemay include a second fastened portion (62) fastened to each of the side frames by the fastening member, the first fastened portion may be provided at a front end portion (401F) of the first subframe, and the second fastened portion may be provided at a rear end portion (402R) of the second subframe.

According to such a configuration, it is possible to fix the fuel cell module to the side frame in a stable posture by fixing the first fuel cell module and the second fuel cell module at distant positions in the front-rear direction of the vehicle.

Although the present disclosure has been detailed, the present disclosure is not limited to the individual embodiments described above. These embodiments may be variously added, replaced, altered, partially deleted, etc., without departing from the scope of the present disclosure or the intent of the present disclosure as derived from the claims and their equivalents. These embodiments can also be implemented in combination. For example, in the above-described embodiment, the order of the operations and the order of the processes are shown as an example, and are not limited to these. The same applies to the case where numerical values or mathematical expressions are used in the description of the above-described embodiment.

1. A fuel cell vehicle comprising:
a vehicle body frame including a pair of side frames facing each other in a vehicle width direction;
a plurality of fuel cell modules; and
a fixing structure configured to fix the plurality of fuel cell modules to the pair of side frames via a fastening member,
wherein
the plurality of fuel cell modules includes
a first fuel cell module, and
a second fuel cell module arranged rearward of the first fuel cell module in a front-rear direction of the fuel cell vehicle,
the fixing structure includes
a first subframe to which the first fuel cell module is fixed,
a second subframe to which the second fuel cell module is fixed, and
a connecting member configured to connect a rear end portion of the first subframe and a front end portion of the second subframe to each other, and
the first subframe, the second subframe, and the connecting member are fastened to the pair of side frames by the fastening member.

2. The fuel cell vehicle according to claim 1, wherein
the first subframe includes
a pair of first side bars spaced apart from each other in the vehicle width direction, and
a first connecting bar configured to connect end portions of the pair of first side bars to each other,
the second subframe includes
a pair of second side bars spaced apart from each other in the vehicle width direction, and
a second connecting bar configured to connect end portions of the pair of second side bars to each other, and
in the front-rear direction of the fuel cell vehicle, bar front end portions of the pair of first side bars are connected to each other by the first connecting bar, and bar rear end portions of the pair of second side bars are connected to each other by the second connecting bar.

3. The fuel cell vehicle according to claim 2, wherein
the connecting member includes
a pair of frame connecting portions extending in the front-rear direction of the fuel cell vehicle and arranged in parallel with each other, and
a connecting portion configured to connect the pair of frame connecting portions to each other,
the connecting member is formed in an H-shape in plan view, and
bar rear end portions of the pair of first side bars and bar front end portion of the pair of second side bars are connected by the pair of frame connecting portions.

4. The fuel cell vehicle according to claim 1, wherein
the first subframe includes a first fastened portion fastened to each of the side frames by the fastening member,
the second subframe includes a second fastened portion fastened to each of the side frames by the fastening member,
the first fastened portion is provided at a front end portion of the first subframe, and
the second fastened portion is provided at a rear end portion of the second subframe.
